(19) United States
(12) Patent Application Publication
(10) Pub. No.: US 2026/0032510 A1
(43) Pub. Date: Jan. 29, 2026

(54) Layer 2 Header Reduction for Non-Terrestrial Networks

(71) Applicant: Apple Inc., Cupertino, CA (US)

(72) Inventors: Fangli XU, Beijing (CN); Chunhai YAO, Beijing (CN); Chunxuan YE, San Diego, CA (US); Haijing HU, Los Gatos, CA (US); Yuqin CHEN, Beijing (CN)

(21) Appl. No.: 19/116,307

(22) PCT Filed: Sep. 29, 2022
(86) PCT No.: PCT/CN2022/122755

§ 371 Date: Mar. 27, 2025

(51) Int. Cl. H04W 28/06

(52) U.S. Cl. CPC H04W 28/06

(57) ABSTRACT

A user equipment (UE) configured to report a VE capability indicating the UE supports a compressed layer 2 (L2) header and receive, from a base station, an indication that the UE is to transmit one or more packets using the compressed L2 header or receive one or more packets with the compressed L2 header.

### TECHNICAL FIELD

The present disclosure generally relates to wireless communication, and in particular, to layer 2 header reduction for non-terrestrial networks.

### BACKGROUND

A non-terrestrial network (NTN) refers to a network or a segment of a network which uses an airborne or a space borne vehicle for transmission. The NTN may provide an NIN cell which covers a wider range of coverage than a terrestrial network (TN) cell provided by a TN. Also, the NTN may have longer delays and lower throughput than the TN. However, when a UE is located within a serving cell of the NTN, the current network may not support voice call services without an enhancement to the voice call services.

### SUMMARY

Some exemplary embodiments are related to a method performed by a user equipment (UE). The method includes reporting a UE capability indicating the UE supports a compressed layer 2 (L2) header and receiving, from a base station, an indication that the UE is to transmit one or more packets using the compressed L2 header or receive one or more packets with the compressed L2 header.

Other exemplary embodiments are related to a method performed by a base station. The method includes receiving, from a user equipment (UE), a UE capability indicating the UE supports a compressed layer 2 (L2) header and sending an indication that the UE is to transmit one or more packets using the compressed L2 header or receive one or more packets with the compressed L2 header.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station according to various exemplary embodiments

FIG. 4 shows a first example compressed layer 2 (L2) header format simplified for voice service transmission according to various exemplary embodiments.

FIG. 5 shows a second example compressed layer 2 (L2) header format simplified for voice service transmission according to various exemplary embodiments.

### DETAILED DESCRIPTION

The exemplary embodiments may be further understood with reference to the following description and the related appended drawings, wherein like elements are provided with the same reference numerals. The exemplary embodiments are related to a compressed layer 2 (L2) header to provide voice coverage enhancements to support voice services on a user equipment (UE) via a non-terrestrial network (NTN).

The exemplary embodiments are described with regard to operations performed by a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate electronic component that is capable of connecting to an NTN and performing voice calls using the NTN.

The exemplary embodiments are also described with reference to a voice service of an NTN network. As will be described herein, the compressed L2 header may provide advantages in this type of application. However, it should be understood that the exemplary embodiments of the compressed L2 header are not limited to this application. The compressed L2 header may be used in any network arrangement that supports the reduced size of the L2 header.

In 5G NR, the NTN may use an airborne vehicle or a space borne vehicle for transmission. In one example, the airborne vehicle may include a satellite, such as a low earth orbit (LEO) satellite, a medium earth orbit (MEO) satellite, a geosynchronous orbit (GEO) satellite, a highly eccentric orbit (HEO) satellite or another type of satellite. In another example, the space borne vehicle may include high altitude platforms (HAPS).

In the exemplary embodiments, the NTN may be used in multiple different scenarios, such as maritime, airplane or railway connectivity scenarios. The NTN addresses mobile broadband needs and public safety needs in unserved or underserved areas. In NR systems, the NTN such as LEO or GEO, may have implicit compatibility to support both HAPS and air-to-ground (ATG) scenarios. In Rel-17 of the 3GPP standards, it was agreed that NTN should focus on frequency division duplexing (FDD) while time division duplexing (TDD) may be applied for relevant scenarios, such as HAPS or ATG. In some instances, the NTN may provide an earth fixed tracking area, and a user equipment (UE) in the NTN may have a GNSS capability.

In other instances, the transmission in the NTN may be a transparent payload for the satellite. The NTN may be available for handheld devices in frequency range 1 (FR1), such as with a power class 3, and for very small aperture terminal (VSAT) devices with an external antenna at least in frequency range 2 (FR2). The NTN may provide an NTN cell with a wider coverage than a TN cell. Specifically, in NTN, the coverage of a cell or a beam is typically much larger than a cell in TN. For example, the coverage of an NTN cell may cross multiple countries in some cases.

This larger coverage area may lead to the NTN having longer delays within the wider coverage while experiencing lower throughput. Also, due to the wider network coverage, the current NTN network fails to support reliable voice services. For instance, under conventional circumstances, voice services require strict time latency to reliably transmit the service through an application layer. However, due to the longer transmission delays in the NTN cell coverage, the voice service reliability fails to provide a reliable transmission for the UE within the cell coverage when connected to voice services. Thus, to support voice services on the UE via the NTN coverage, the exemplary embodiments provide voice specific coverage enhancements to efficiently support services such as voice calls on the UE.

The exemplary embodiments relate to introducing improved voice services such as an improved performance of low-rate codecs in link budget limited situations including reducing RAN protocol overhead for voice over NR (VONR) services. Under current conditions, the type of header used in the L2 Protocol Data Unit (PDU) for smaller packets of data is an at least 6-byte L2 header. The over the air (OTA) header for the 6-byte L2 header length may include at least 1 byte of Service Data Adaptation Protocol (SDAP) if the header is configured, 3 bytes of Packet Data Convergence Protocol (PDCP) for 18-Bit Sequence Number (SN) or 2 bytes of PDCP for 12-Bit SN, 3 bytes of Radio Control Layer (RLC) for 18-Bit for SN acknowledgement mode (AM) or 1-byte for UMD without segmentation and 2 bytes of Medium Access Control (MAC). However, the current L2 header design fails to boost coverage gain for the NTN cell.

The exemplary embodiments introduce an improved L2 header design that improves the voice service transmission performance for the UE in the NTN. For instance, in the exemplary embodiment, a shorter L2 header design may boost the coverage gain in the NTN, which will be important for UEs experiencing low signal-to-noise ratio (SNR) in the NTN.

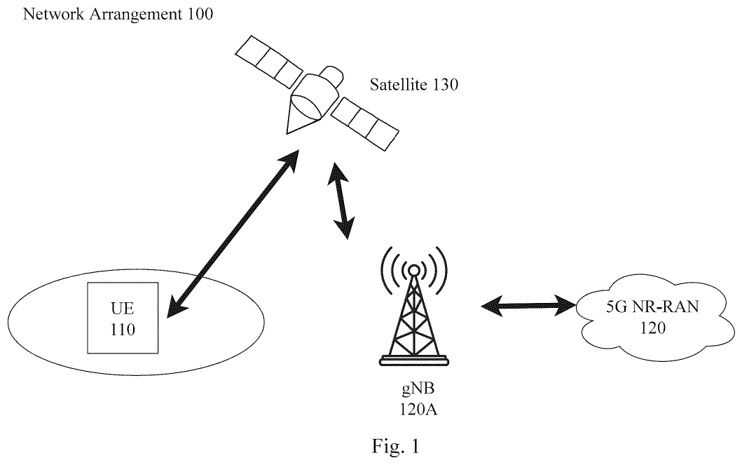

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., sixth generation (6G) RAN, a 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120.

The UE 110 may connect to the gNB 120A via a satellite 130. The satellite 130 may communicate with the DE 110 via a service link or a wireless interface. The satellite 130 may further communicate with the gNB 120A via a feeder link or a wireless interface. In some embodiments, the satellite 130 may operate as a passive or transparent network relay node between the UE 110 and the gNB 120A. Those skilled in the art will understand that any association procedure may be performed for the satellite 130 to connect to the UE 110 and the gNB 120A.

Those skilled in the art will understand that the network arrangement 100 may also include various other networks and components such as a cellular core network, the Internet, an IP Multimedia Subsystem (IMS), etc. However, these other networks/components are not relevant to the exemplary embodiments and are therefore not described in any greater detail.

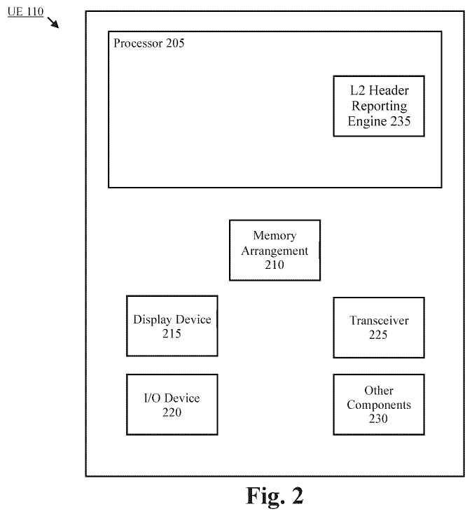

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include an L2 header engine 235. The L2 header engine 235 may perform various operations related to the exemplary reduced PDU format including a capability of the UE 110 with respect to the compressed L2 header, assembling PDUs using the compressed L2 header for transmission and decoding received PDUs having the compressed L2 header. These operations will be described in greater detail below.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies).

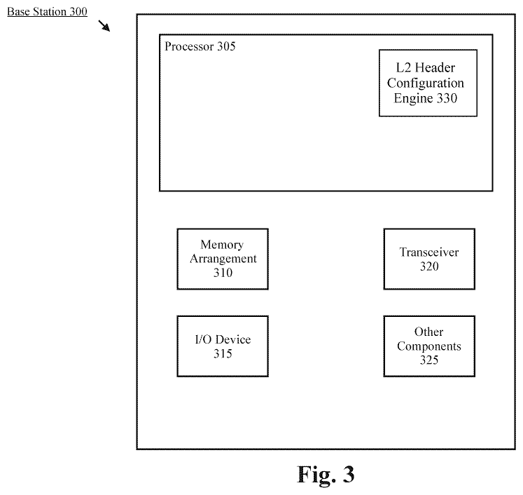

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include a L2 header configuration engine 330. The L2 header configuration engine 330 may perform various operations related to the exemplary compressed L2 header format such as configuring the UE 110 to transmit and receive PDUs having the compressed L2 header format. The operations will be described in greater detail below.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs.

As described above, the exemplary embodiments relate to introducing a simplified L2 header format for voice service transmission in NTN. In some exemplary embodiments, the simplified L2 header format may be enabled via a radio resource control (RRC) configuration when the voice service is configured. In one option, the RRC configuration could be per UE. In another option, the RRC configuration could be per bearer. Thus, in some embodiments, when the L2 header format is enabled by the network, the UE may be configured to follow the new format to assemble or decode the packet which is transmitted via a special uplink (UL) grant or downlink (DL) assignment. In other embodiments, the UE may be configured to follow a special logical channel ID (LCID) to decode the special L2 header format. The following will provide examples of the simplified L2 header that the UE 110 may use to transmit voice services.

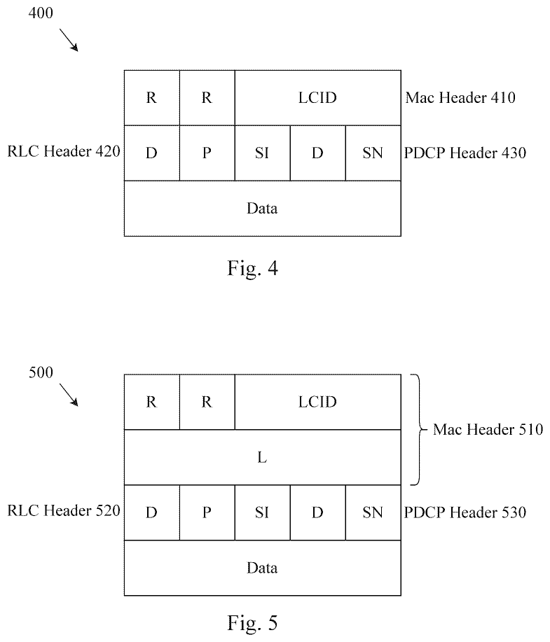

FIG. 4 shows a first example compressed layer 2 (L2) header format 400 simplified for voice service transmission according to various exemplary embodiments. In one aspect, a new L2 header format implementing a 2-byte format instead of the 6-byte format is introduced. In another aspect, a 3-byte format may be introduced. In the exemplary embodiments, the L2 header format is compressed to generate the simplified L2 header format (e.g., 2-byte format, or 3-byte format). The example of FIG. 4 shows the 2-byte format. FIG. 5 will show the 3-byte format.

As shown in FIG. 4, the simplified L2 header may include a medium access control (MAC) header 410, a radio link control (RLC) header 420 and a packet data convergence protocol (PDCP) header 430. The MAC header 410 may be compressed to 1-byte carrying the LCID that may be used to identify the type of service for which the packet is being transmitted (e.g., a voice service). That is, the LCID identifies the logical channel carried in the MAC header 410 of the L2 header.

The RLC header 420 as shown in FIG. 4 may be compressed to 4-bits comprising a packet type (D) such as control or data type, polling bit (P) and a segmentation indication (SI). For instance, in the exemplary embodiment, the SI carried on the RLC header 420 may indicate whether the packet is a segment or not. Thus, if the packet is not segmented, the SI may be set to 0. Otherwise, if the packet is segmented, the SI may be set to a value other than 0. Additionally, the data packet may indicate whether the package contained in the RLC header 420 may be utilized for control purposes or data purposes. Subsequently, the P bit may carry polling information for the RLC header 420. However, in the exemplary embodiments, if the simplified L2 header format is for un-acknowledged mode (UM-mode), D and P of the RLC header 420 may be omitted or marked as R-byte (reserved) in the RLC header 420 of the simplified L2 header. Otherwise, D and P of the RLC header 420 may be maintained as indicated in FIG. 4 if the use of the packet is to be extended.

Further in FIG. 4, the PDCP header 430 may be compressed to 4-bits carrying a packet type (e.g., control or data) and PDCP sequence number (SN). In one aspect, if it is assumed that the simplified L2 header 400 may be used for PDCP control packet which could be used for PDCP route feedback, then the D packet type may be present in the PDCP header 430. In another aspect, the UE 110 may utilize the SN to perform duplication detection. For instance, when the packet is received out of order, the PDCP header may use the SN to order and provide the packet for delivery.

FIG. 5 shows a second example compressed layer 2 (L2) header format 500 simplified for voice service transmission according to various exemplary embodiments. As stated above, the L2 header format 500 is a 3-byte format. The L2 header format 500 includes the same headers as FIG. 4, the MAC header 510, the RLC header 520 and the PDCP header 530. The RLC header 520 and the PDCP header 530 are the same as the corresponding headers described above for the L2 header format 400 and therefore will not be described above.

Similarly, the first byte of the MAC header 510 includes the same fields as that described above for the L2 header format 400, e.g., the two reserved fields (R) and the LCID field. The difference in the MAC header 510 is that it also includes an L field. The L field indicates the byte number of the payload part of the MAC PDU. The L field allows the MAC PDU to have a variable length. Without the L field, the MAC PDU has a fixed length (e.g., equal to the UL grant size or DL assignment size). The L field may have a fixed size, e.g., 2-Byte MAC header with 1-Byte L field, or the L field may also have a less than 1-Byte size, e.g., 1-Byte MAC header with a short-length L field.

In the exemplary embodiments, to reduce the L2 header format, the packet transmission may be limited based on some assumptions as described below. In one aspect, the L2 header format may be reduced to support only 1:1 mapping between the MAC PDU, RLC PDU and PDCP PDU. In another aspect, a new L2 PDU format with a shorter SN (for example 3 bytes) may be assumed because under current circumstances, the SN can only support 18 bytes or L2 bytes. In another aspect, the RLC and PDCP SN can be assumed to be 1:1 mapping to skip the RLC SN. Based in this assumption, segmentation may be skipped as well. In a further aspect, the packet may be delivered in the new format if it meets the packet requirements, otherwise the packet may be delivered using a legacy format. Additionally, in another aspect, a special LCID can be introduced and used to identify the MAC PDU with the enhanced L2 format. Those skilled in the art will understand that the assumptions are not limited to these only and that a combination of any these, or any other appropriate assumption may be utilized.

In the exemplary embodiments, the header reduction may be based on the capability of the UE 110. For instance, in the exemplary embodiments, the gNB 120A may configure the UE 110 to report its capabilities of either supporting a new L2 header or not. The UE 110 may report the capabilities to the network. Based on the capability report, the network may enable the feature through RRC signaling. Accordingly, the network may provide the RRC configuration to the UE 110 with this capability. In another instance, the trigger of the L2 header may be due to a bad channel condition. That is, normal PUSCH or PDSCH has a coverage issue for the UE. In some exemplary embodiments, the configuration may be enabled for specific logical channel(s) or a specific radio bearer(s).

As mentioned above, the exemplary embodiments introduce examples of simplified L2 header that the UE 110 may use to transmit voice services as will be described below.

In one exemplary embodiment, the UE 110 may be configured to identify the L2 PDU with the simplified L2 header format according to the special UL grant or DL assignment. The example will be described with regard to the network arrangement 100 of FIG. 1 and the UE 110 of FIG. 2. In this example, the network may enable the special UL grant or DL assignment via some following options. In one option, the network may configure the special PDCCH for the transmission of a PDU with new L2 format via RRC signaling. In a second option, the network may explicitly indicate which semi-persistent scheduling (SPS) or configured grant (CG) is used for the new L2 format by RRC signaling. In a third option, the network may dynamically indicate the format information per dynamic grant or per configured grant. In a fourth option, the network can enable or disable the feature via the MAC CE on top of option one or two. Some factors such as UE radio quality, UE preference and service quality that impact the network decision to enable or disable the feature.

In the exemplary embodiments, for the transmission according to the special UL grant to occur, the UE 110 may be configured to only assemble the MAC PDU from the special bearer with the new format. For the receiving side of the UE 110 operation, when the UE 110 receives the MAC PDU via the PDSCH which is scheduled via the special DL assignment, the UE 110 MAC will be configured to decode the packet according to the simplified L2 header format.

In another exemplary embodiment, the UE 110 may be configured to identify the L2 PDU with the simplified L2 header format by special LCID. The example will be described with regards to the network arrangement 100 of FIG. 1 and the UE 110 of FIG. 2. In this example, the network may enable the special L2 PDU format for a radio bearer to configure the special LCID for this radio bearer. That is, the network can configure two LCID for the same bearer, configuring one for a legacy L2 format, and another for the new L2 format header. In another example, the UE 110 may be configured to identify the same bearer by the configured LCID. This allows the UE 110 to select the legacy LCID and the special LCID based on whether the new L2 header PDU format is selected.

In the exemplary embodiments, after the network provides the radio bearer level configuration, the network may also enable or disable the feature via L1/L2 signaling. Additionally, the network may configure the association between the special LCID together with a special UL grant or DL assignment.

In the exemplary embodiments, if the transmission occasion can be used for the new PDU format based on configuration or another indication, the UE 110 may be configured to assemble the MAC PDU with the special LCID according to the new PDU format. For the receiving side of the UE 110 operation, when the UE 110 receives the MAC PDU with the special LCID, the UE 110 will be configured to decode the MAC subPDU/MAC PDU packet according to the new simplified L2 header format.

In a further example, the UE 110 operation for the bearer with the new L2 PDU format configuration is described in further options below. In one option, the UE 110 may select the PDU form according to the available data amount and the provided UL grant size. That is, if the UL grant can accommodate the available data of the bearer with the new PDU format, then the UE 110 may select the assemble L2 PDU according to the new format. However, if the UL grant cannot accommodate the available data of the bearer with the new PDU format, the UE 110 may perform one of two functions.

First, the UE 110 may select the legacy PDU format to assemble the PDU. Second, the UE 110 may use the UL grant for the control data transmission instead. In a second option, the UE 110 may always use the new L2 PDU format for the special UL grant transmission. That is, if the available data is greater than the UL grant size, the UE 110 may perform the segmentation and insert it in the L2 PDU with the new format. However, for the leftover data, the data may be delivered via the other UL grant with the legacy format.

### EXAMPLES

In a first example, a processor of a user equipment (UE) is configured to perform operations comprising reporting a UE capability indicating the UE supports a compressed layer 2 (L2) header and receiving, from a base station, an indication that the UE is to transmit one or more packets using the compressed L2 header or receive one or more packets with the compressed L2 header.

In a second example, the processor of the first example, wherein the indication is received via radio resource control (RRC) signaling.

In a third example, the processor of the first example, wherein the indication is an L2 configuration indicating a transmission configuration and a reception configuration.

In a fourth example, the processor of the first example, wherein the indication is a special uplink (UL) grant or a special downlink (DL) assignment.

In a fifth example, the processor of the fourth example, wherein the special UL grant or special DL assignment is signaled in a Physical Downlink Control Channel (PDCCH).

In a seventh example, the processor of the fourth example, wherein the special UL grant or special DL assignment is explicitly signaled in radio resource control (RRC) signaling comprising semi-persistent scheduling (SPS) or a configured grant (CG).

In a seventh example, the processor of the fourth example, wherein the special UL grant or special DL assignment is indicated per dynamic grant or per configured grant.

In an eighth example, the processor of the fourth example, wherein the special UL grant or special DL assignment is indicated via a MAC control element (MAC-CE).

In a ninth example, the processor of the fourth example, wherein, when the special UL grant is indicated, the operations further comprise assembling a MAC protocol data unit (PDU) having the compressed L2 header and transmitting the MAC PDU using a resource of the special UL grant.

In a tenth example, the processor of the fourth example, wherein, when the special DL assignment is indicated, the operations further comprise receiving a MAC PDU in a resource of the special DL assignment and decoding the MAC PDU according to the compressed L2 header format.

In an eleventh example, the processor of the first example, wherein the indication is a special logical channel identification (LCID) for a radio bearer.

In a twelfth example, the processor of the first example, the operations further comprising assembling a MAC PDU using one of the compressed L2 header format or a legacy L2 header format based on a size of data to be transmitted in the MAC PDU.

In a thirteenth example, the processor of the first example, wherein the compressed L2 header comprises a 1-byte MAC header comprising an indication of a logical channel identification (LCID) for which the compressed L2 header is to be used.

In a fourteenth example, the processor of the first example, wherein the compressed L2 header comprises a 2-byte MAC header comprising an indication of a logical channel identification (LCID) for which the compressed L2 header is to be used and an L field indicating a byte number of a payload part of a Medium Access Control (MAC) Protocol Data Unit (PDU).

In a fifteenth example, the processor of the first example, wherein the compressed L2 header comprises a 4-bit RLC header comprising an indication of a packet type, a polling bit and a segment indication (SI).

In a sixteenth example, the processor of the first example, wherein the compressed L2 header comprises a 4-bit PDCP header comprising an indication of a packet type and a PDCP sequence number.

In a seventeenth example, a user equipment comprises a transceiver configured to communicate with a network and the processor of any of the first through fifteenth examples communicatively coupled to the transceiver.

In an eighteenth example, a non-transitory computer readable storage medium comprising a set of instructions executable to perform any of the operations of the first through fifteenth examples.

In a nineteenth example, a method performed by a base station, comprising receiving, from a user equipment (UE), a UE capability indicating the UE supports a compressed layer 2 (L2) header and sending an indication that the UE is to transmit one or more packets using the compressed L2 header or receive one or more packets with the compressed L2 header.

In a twentieth example, the method of the nineteenth example, wherein the indication is sent via radio resource control (RRC) signaling.

In a twenty first example, the method of the nineteenth example, wherein the indication is an L2 configuration indicating a transmission configuration and a reception configuration.

In a twenty second example, the method of the nineteenth example, wherein the indication is a special uplink (UL) grant or a special downlink (DL) assignment.

In a twenty third example, the method of the twenty second example, wherein the special UL grant or special DL assignment is signaled in a Physical Downlink Control Channel (PDCCH).

In a twenty fourth example, the method of the twenty second example, wherein the special UL grant or special DL assignment is explicitly signaled in radio resource control (RRC) signaling comprising semi-persistent scheduling (SPS) or a configured grant (CG).

In a twenty fifth example, the method of the twenty second example, wherein the special UL grant or special DL assignment is indicated per dynamic grant or per configured grant.

In a twenty sixth example, the method of the twenty second example, wherein the special UL grant or special DL assignment is indicated via a MAC control element (MAC-CE).

In a twenty seventh example, the method of the nineteenth example, wherein the indication is a special logical channel identification (LCID) for a radio bearer.

In a twenty eighth example, the method of the nineteenth example, wherein the compressed L2 header comprises a 1-byte MAC header comprising an indication of a logical channel identification (LCID) for which the compressed L2 header is to be used.

In a twenty ninth example, the method of the nineteenth example, wherein the compressed L2 header comprises a 2-byte MAC header comprising an indication of a logical channel identification (LCID) for which the compressed L2 header is to be used and an L field indicating a byte number of a payload part of a Medium Access Control (MAC) Protocol Data Unit (PDU).

In a thirtieth example, the method of the nineteenth example, wherein the compressed L2 header comprises a 4-bit RLC header comprising an indication of a packet type, a polling bit and a segment indication (SI).

In a thirty first example, the method of the nineteenth example, wherein the compressed L2 header comprises a 4-bit PDCP header comprising an indication of a packet type and a PDCP sequence number.

In a thirty second example, a processor configured to perform any of the methods of the nineteenth through thirty first examples.

In a thirty third example, a base station comprises a transceiver configured to communicate with a user equipment (UE) and a processor configured to perform any of the methods of the nineteenth through thirty first examples.

In an thirty fourth example, a non-transitory computer readable storage medium comprising a set of instructions executable to perform any of the methods of the nineteenth through thirty first examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method performed by a user equipment (UE), comprising:
reporting a UE capability indicating the UE supports a compressed layer 2 (L2) header format; and
receiving, from a base station, an indication that the UE is to transmit one or more packets using the compressed L2 header format or receive one or more packets with the compressed L2 header format.

2. The method of claim 1, wherein the indication is received via radio resource control (RRC) signaling.

3. The method of claim 1, wherein the indication is an L2 configuration indicating a transmission configuration and a reception configuration.

4. The method of claim 1, wherein the indication is a special uplink (UL) grant or a special downlink (DL) assignment.

5. The method of claim 4, wherein the special UL grant or special DL assignment is signaled in a Physical Downlink Control Channel (PDCCH).

6. The method of claim 4, wherein the special UL grant or special DL assignment is explicitly signaled in radio resource control (RRC) signaling comprising semi-persistent scheduling (SPS) or a configured grant (CG).

7. The method of claim 4, wherein the special UL grant or special DL assignment is indicated per dynamic grant or per configured grant.

8. The method of claim 4, wherein the special UL grant or special DL assignment is indicated via a MAC control element (MAC-CE).

9. The method of claim 4, wherein, when the special UL grant is indicated, the method further comprises:
assembling a MAC protocol data unit (PDU) having the compressed L2 header format; and
transmitting the MAC PDU using a resource of the special UL grant.

10. The method of claim 4, wherein, when the special DL assignment is indicated, the method further comprises:
receiving a MAC PDU in a resource of the special DL assignment; and
decoding the MAC PDU according to the compressed L2 header format.

11. The method of claim 1, wherein the indication is a special logical channel identification (LCID) for a radio bearer.

12. The method of claim 1, further comprising:
assembling a MAC PDU using one of the compressed L2 header format or a legacy L2 header format based on a size of data to be transmitted in the MAC PDU.

13. The method of claim 1, wherein the compressed L2 header format comprises a 1-byte MAC header comprising an indication of a logical channel identification (LCID) for which the compressed L2 header format is to be used.

14. The method of claim 1, wherein the compressed L2 header format comprises a 2-byte MAC header comprising an indication of a logical channel identification (LCID) for which the compressed L2 header format is to be used and an L field indicating a byte number of a payload part of a Medium Access Control (MAC) Protocol Data Unit (PDU).

15. The method of claim 1, wherein the compressed L2 header format comprises a 4-bit RLC header comprising an indication of a packet type, a polling bit and a segment indication (SI).

16. The method of claim 1, wherein the compressed L2 header format comprises a 4-bit PDCP header comprising an indication of a packet type and a PDCP sequence number.

17. A method performed by a base station, comprising:
receiving, from a user equipment (UE), a UE capability indicating the UE supports a compressed layer 2 (L2) header format; and
sending an indication that the UE is to transmit one or more packets using the compressed L2 header format or receive one or more packets with the compressed L2 header format.

18. The method of claim 17, wherein the indication is sent via radio resource control (RRC) signaling.

19. The method of claim 17, wherein the indication is an L2 configuration indicating a transmission configuration and a reception configuration.

20. The method of claim 17, wherein the indication is a special uplink (UL) grant or a special downlink (DL) assignment.
